(19) United States
(12) Patent Application Publication
(10) Pub. No.: US 2006/0236830 A1
(43) Pub. Date: Oct. 26, 2006

(54) Individualized cutting and creasing device and method of producing the same

(76) Inventor: John Michael Fischer, Menomonee Falls, WI (US)

Correspondence Address: RYAN KROMHOLZ & MANION, S.C., POST OFFICE BOX 26618, MILWAUKEE, WI, 53226, US

(21) Appl. No.: 11/205,674

(22) Filed: Aug. 17, 2005

Related U.S. Application Data
(60) Provisional application No. 60/673,643, filed on Apr. 21, 2005.

(51) Int. Cl. B26D 1/00

(52) U.S. Cl. 83/13

(57) ABSTRACT

A customized cut/crease device and a method for making same.

### RELATED APPLICATION

This application claims the benefit of U.S. Provisional Patent Application Ser. No. 60/673,643, filed 21 Apr. 2005, and entitled “Individualized Cutting and Creasing Device and Method of Producing the Same.”

### BACKGROUND OF THE INVENTION

The present invention relates to devices for cutting and scoring planar material and, more specifically to dies designed for cut and crease operations.

Cutting dies are used in a cutting press in which various thickness of paper or card stock are cut to desired shapes. A good example of a box cut with a press is an ordinary cereal box or snack boxes, such as used for fruit snacks or granola bars. Nearly all paper or cardboard display devices, including boxes, table tents (displays used in restaurants or bars), folders, greeting cards, gaskets, mailers and the like are cut and creased using steel rule cutting dies. In the past ten years, the market has become very competitive for creating steel rule dies for the cutting industry due to automated machines that have taken some of the work out of hand bending the steel rule used in the dies. To describe more in detail how a die is made, the process is broken into 3 major departments.

A design department uses Adobe Illustrator® or Cimex® programs to create a die line of the product that will be cut or crease. Some customers may create their own dyelines, while others will create dyelines using CAD drawings. A designer can create a die line using dimensions from a drawing or be created simply from a sample using a digitizer. The digitizer will plot certain points of a sample using a mouse and a magnetic board to locate the exact critical points for the die line. The designer will than use different colors of lines to differentiate between cutting lines, creasing lines (also called score lines) and perforating lines. There are many other variations of rule, but these are the major three that exemplify the die is and how it is used. Using extreme accuracy in the layout of the die is critical because this program is also used in the lasering process.

A ⅝ or ¾ inch thick 5 or 7 ply maple board is positioned on the laser bed and leveled to hold perfect perpendicularity of the laser beam. The laser is commanded to burn the die line created in the design department within 0.001 inch (1 mil) tolerance. The burn (or lasered groove) is done in certain widths that the industry uses as standards such as a 2 point (pt) burn (28 mil) or 3 pt burn (42 mil). The burn can actually be created using any pointage, but is usually consistent with the standards. When using the shim stock method to install cut/crease an adjustment of the burn is required to be 3.5 pt. The thickness of the rule is 2 pt; the shim stock is 1 pt (0.5 pt each) and also adds for the thickness of the adhesive used on the shim stock. After this lasering is done, the die is ready to be sent to the knifing department to have the all the rule installed.

Cutting rule is used to cut through for example, the perimeter of the cereal box. The standard heights of the cutting rules are 0.918 inch and 0.937 inch, depending on how the customer's press is set up. When either is used, then a whole list of scoring rules can be used but are determined by the thickness of the material being cut. The scores are used when a fold (or crease) is needed to create the desired shape. On certain materials the score is not heavy enough to get the desired range in the bending of the material. In this case a combination of a cut and score rule is used. For example, if a die is using a 0.937 inch cut rule and a 0.912 inch scoring rule and the material needs to fold, a piece of cut/crease is created. A piece of crease will be put in the board and then cut and this pattern will continue for the length of the line. Tick marks are usually etched into the very top layer of the board to show the location of each piece. This method poses several problems including the following:

1) The smaller pieces sometimes, as small as 3/16″, can become loose and fall out of the board. If the quality control department running the press does not catch the loose piece quickly, much time and material is lost. Replacement of the pieces can be difficult and re-ruling (replacing the rule due to wear) sometimes cannot be done due to wear and the pieces not staying in the die.

2) Installation is very labor intensive.

3) Shifting of the rule can cause uneven cut and crease lines.

Another way of performing cut/crease operations is by buying machined cut/crease rule that can be cut to length and put in the die as a full length piece but also has problems associated with it as follows:

1) The availability of specific combinations of rule is very limited. For example: the combinations of the cut/crease are usually sold in ⅛″×⅛″ (the first size being the cut and the second being the crease), ¼″×¼″, ½″×½″.

2) The heights of the rule for the crease in the combinations are very limited and may not be suitable for all applications. Each job has a different thickness of material and may require a special height crease.

3) Most jobs are time sensitive and normally only a 24-hour lead-time is given. If the cut/crease is special ordered, on average a lead-time of at least two weeks is needed to receive the proper cut/crease rule.

4) The crease that is machine cut is not rounded, as is regular crease. When the machine cuts the crease, it makes square corners and these can cause cracking in some materials.

The prior art does not allow or contemplate cut/crease devices that may be assembled with a short lead-time or to specific configurations. Thus, it is desirable to provide a cut/crease device or arrangement to economically and efficiently address these problems.

### SUMMARY OF THE INVENTION

The present invention is for an individualized cut/crease device and a method of manufacturing the device. An adhesive is placed on a first piece of shim stock. A plurality of individual cut and crease pieces are selected, having any range of heights and widths. The cut and crease devices are placed on the shim stock. A second shim stock is adhered to the cut and crease devices, thereby securing the cut and crease devices between the two shim stock.

### BRIEF DESCRIPTION OF THE DRAWINGS

FIG. 1 is a perspective view of a prior art structure.

FIG. 2 is an exploded view of a cut/crease device in accordance with the present invention.

FIG. 3 is a perspective view of a cut/crease device in accordance with the present invention.

FIG. 4 is a perspective view of another embodiment of a cut/crease device in accordance with the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention.

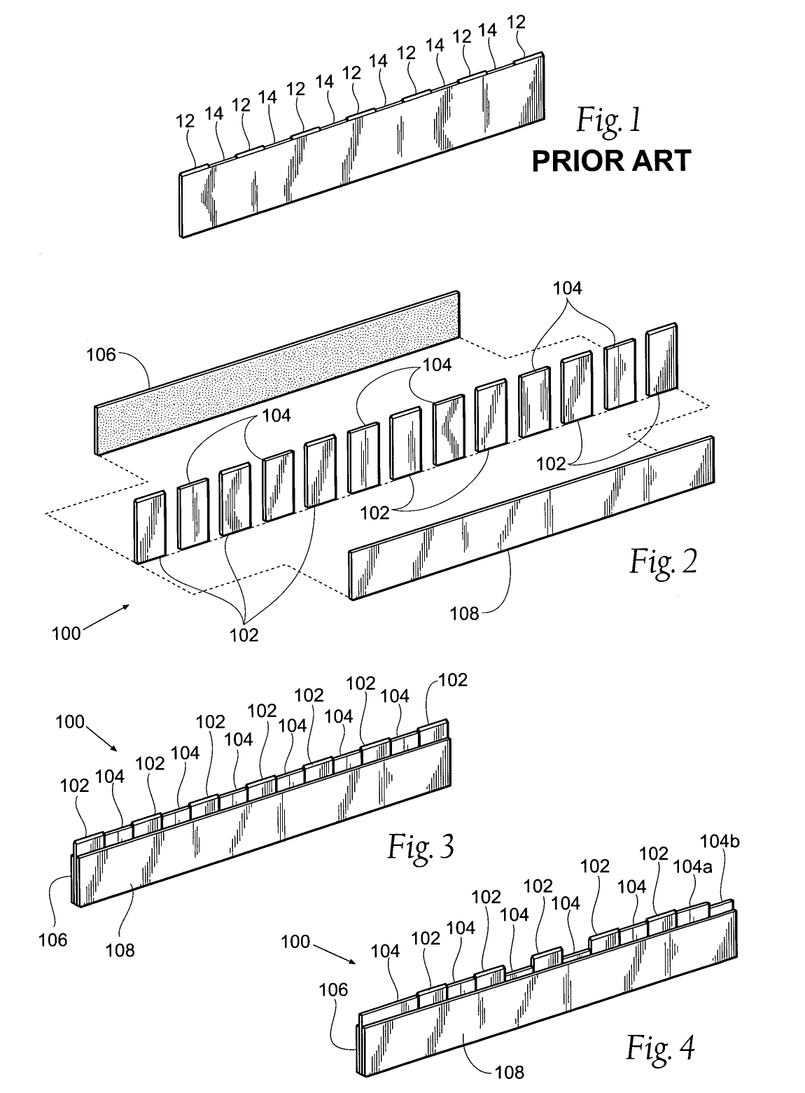

FIG. 1 shows a prior art cut and crease device 10. The device 10 has a plurality of cut sections 12 alternating with a plurality of crease sections 14. While the device will adequately cut and crease a piece of cardboard or the like, it cannot be adapted for specific uses. It is machined and manufactured as a single device. If changes are required for how a specific, customized project is to be cut and creased, such as having different depths or widths of the cut and/or crease, it will require a completely new device to be machined, which can cause significant delay in the process.

FIGS. 2 and 3 show a cut and crease device 100 according to the present invention. Cut rules 102 and crease rules 104 are cut to desired length using a manual rule cutter or automated bending equipment. The first of two adhesive backed shim stock strips 106, (usually ½ point (7 mil) each) is cut to a desired length. Preferably, the adhesive is protected by a tape, which should be peeled back exposing the tacky side of the shim stock 106 and laid flat on a workbench (not shown). Crease rule 104 preferably is used as the first piece in cut/crease because the material will be folded. If cut rule 102 is used first, the material has a greater chance that it will tear when folded. The first piece of crease 104 is placed on the tacky shim stock 106 as square as possible and then a piece of cut 102, following this pattern as required by the customer until the other end of the shim stock is reached. The second piece of shim stock 108 is placed over the first piece 106 as exact as possible. The two pieces can be adhered together by hand. Then, using a flat die and a hand press (not shown), run the finished piece 100 through hand press, squeezing and compressing the two pieces together. The piece 100 is now ready to install. If any part of the assembled piece is not exactly square it will be straightened out with the first hit in the press.

The present invention is not only advantageous in reducing the time needed for performing cut/crease operations and producing cut/crease products, but it also allows an individual to customize the cut/crease device. For instance, it may be possible that all of the cuts and/or creases are not desired to have the same dimensions. The final product may need a first cut that is longer or shorter than the other cuts, and the first crease may be longer or shorter than the other cuts, as well. As shown in FIG. 4, the cut rule 102 and the crease rule 104, this allows for an individualized product that can be made quickly and efficiently. Likewise the depth of the cut or crease may be varied from one cut or crease to another. Furthermore, creases of varying depths could be positioned next to one another. The arrangements are numerous, which give the user more flexibility when designing products. The device 100 could also be used for curvilinear arrangements, but the device 100 is most utile for linear arrangements. Provided that a formed device comprises a laminate having a inner layer comprised of a plurality of individual cut rule and crease rule adjacently positioned to one another, a device would fall within the scope of the present invention.

The foregoing is considered as illustrative only of the principles of the invention. Furthermore, since numerous modifications and changes will readily occur to those skilled in the art, it is not desired to limit the invention to the exact construction and operation shown and described.

I claim:

1. An individualized cutting and creasing device comprising a multilayered laminate and wherein said laminate includes:
a first layer of shim stock;
a second layer of adhesive applied to said first layer of shim stock;
a third layer comprising a plurality of adjacently positioned individual cut rule and crease rule adhered to said first piece of shim stock;
a fourth layer of adhesive applied over said layer of cut rule and crease rule; and
a fifth layer of shim stock adhering to said fourth layer of layer.

2. The device according to claim 1 wherein said third layer comprises alternately cut rule and crease rule.

3. The device according to claim 1 wherein at least one of said individual crease rules is of a different width than the other of said crease rule.

4. The device according to claim 1 wherein at least one of said individual cut rule is of a different width than the other of said crease rule.

5. The device according to claim 1 wherein said at least one of said individual crease rule is of a different depth than the other of said crease rule.

6. The device according to claim 1 wherein said first layer said fifth layer of shim stock are equal in length.

7. A method of making a cut and crease device comprising the steps of:
providing a first and second piece of shim stock;
providing a plurality of individualized cut rule;
providing a plurality of individualized crease rule;
adjacently adhering said cut and crease to said first shim stock; and
adhering said second shim stock over said crease and cut rule.

8. The method of claim 7 wherein said cut rule and said crease rule are adhered to said first shim stock in an alternating fashion.

9. The method according to claim 7 wherein at least one of said provided individual crease rule is of a different width than the other of said crease rule.

10. The method according to claim 7 wherein at least one of said provided individual cut rule is of a different width than the other of said crease rule.

11. The method according to claim 7 wherein said at least one of said provided individual crease rule is of a different depth than the other of said crease rule.

12. The method according to claim 7 wherein said first and said second shim stock are equal in length.
